(19) United States
(12) Patent Application Publication
(10) Pub. No.: US 2010/0218858 A1
(43) Pub. Date: Sep. 2, 2010

(54) NANOSTRUCTURED MN-AL PERMANENT MAGNETS AND METHODS OF PRODUCING SAME

(76) Inventors: Ian Baker, Etna, NH (US); Qi Zeng, Belvidere, IL (US)

Correspondence Address: LATHROP & GAGE LLP, 4845 PEARL EAST CIRCLE, SUITE 201, BOULDER, CO, 80301, US

(21) Appl. No.: 12/089,876

(22) PCT Filed: Oct. 27, 2006
(86) PCT No.: PCT/US06/41790

§ 371 Date: Apr. 23, 2010

Related U.S. Application Data
(60) Provisional application No. 60/730,697, filed on Oct. 27, 2005.

(51) Int. Cl. C22F 1/18; H01F 1/047; C22C 22/00

(52) U.S. Cl. 148/559; 148/314

(57) ABSTRACT

Nanostructured Mn—Al and Mn—Al—C permanent magnets are disclosed. The magnets have high coercivities (˜4.8 kOe and 5.2 kOe, respectively) and high saturation magnetization values. The magnets are prepared from cost effective and readily available elements using a novel mechanical milling and annealing method.

### RELATED APPLICATIONS

This application claims priority to U.S. Patent Application No. 60/730,697, filed Oct. 27, 2005, which is incorporated by reference herein.

### GOVERNMENT INTERESTS

The United States Government may have certain rights in the present invention as research relevant to its development was funded by the National Institute of Standards and Technology (NIST) contract number 60NANB2D0120.

### BACKGROUND

Magnets may be broadly categorized as temporary or permanent. Temporary (soft) magnets become magnetized or demagnetized as a direct result of the presence or absence of an externally applied magnetic field. Temporary magnets are used, for example, to generate electricity and convert electrical energy into mechanical energy in motors and actuators. Permanent (hard) magnets remain magnetized when they are removed from an external field. Permanent magnets are used in a wide variety of devices including motors, magnetically levitated trains, MRI instruments, and data storage media for computerized devices.

High-performance permanent magnets, such as Sm—Co (H_{C}=10-20 kOe) and Nd—Fe—B (H_{C}=9-17.5 kOe), are generally intermetallic alloys made from rare earth elements and transition metals, such as cobalt. However, the high cost of rare earth elements and cobalt makes the widespread use of high-performance magnets commercially impractical. Less expensive magnets are more commonly used, but these magnets generally have lower coercive forces, H_{C}, i.e., their internal magnetization is more susceptible to alteration by nearby fields. For example, ferrites, which are predominantly iron oxides, are the cheapest and most popular magnets, but they have both low coercive forces (˜1600-3400 Oe) and low values of magnetization. Similarly, aluminum-nickel-cobalt (“Alnico”) alloys which contain large amounts of nickel, cobalt and iron and small amounts of aluminum, copper and titanium, have coercive forces in the range of 600-1400 Oe, which makes exposure to significant demagnetizing fields undesirable.

More recently, Mn—Al—(C) alloys have been produced by mechanical alloying processes. D. C. Crew, P. G. McCormick and R. Street, Scripta Metall. Mater., 32(3), p. 315, (1995) and T. Saito, J. Appl. Phys., 93(10), p. 8686, (2003) have shown that adding small amounts of carbon (e.g., about 2 atomic % or less) to certain Mn—Al alloys stabilizes the metastable τ phase and improves magnetic properties and ductility. Crew et al. (1995) produced Mn₇₀Al₃₀ weight % and Mn_{70.7}Al_{28.2}C_{1.1} weight % alloys by consolidating ball milled powders, annealing at 1050° C. and then quenching, after which the materials were no longer nanocrystalline. The resulting alloys had grain sizes of about 300-500 nm and exhibited coercivities, H_{C}, of 1.4 kOe and 3.4 kOe, respectively. Saito (2003), produced mechanically alloyed Mn₇₀Al₃₀ weight % and Mn₇₀Al_{29.5}C_{0.5} weight % alloys that had grain sizes of about 40-60 nm and coercivities of 250 Oe and 3.3 kOe, respectively. In this study, the low coercivities reflected the limited formation of the magnetic r phase, which was determined to be 10% in Mn₇₀Al₃₀ and 40% in Mn₇₀Al_{29.5}C_{0.5}. K. Kim, K. Sumiyama and K. Suzuki, J. Alloys Comp., 217, p. 48, (1995), produced MnAl alloys that were ball milled, but never annealed. The alloys displayed no hard magnetic properties, H_{C}=130 Oe. These Mn—Al alloys are made from relatively inexpensive materials, but the low coercivities remain a problem.

### SUMMARY

The subject matter of the present disclosure advances the art and overcomes the problems outlined above by providing nanostructured Mn—Al alloys and a method for their manufacture. Constituents of these alloys may be mechanically milled and heat-treated to form permanent room temperature magnets with high coercivities and relatively high saturation magnetization values.

In one embodiment, an intermetallic composition includes a nanostructured manganese aluminum alloy having at least about 80% of a magnetic phase and permanent magnetic properties at room temperature.

In one embodiment, a nanostructured manganese aluminum alloy includes at least about 80% of a magnetic τ phase and has a macroscopic composition of Mn_{X}Al_{Y}Do_{Z}, wherein Do is a dopant, X ranges from 52-58 atomic %, Y ranges from 42-48 atomic %, and Z ranges from 0 to 3 atomic %.

In one embodiment, a method of producing an intermetallic composition includes heating a mixture of metals that contains between 52-58 atomic % manganese and between 42-48 atomic % aluminum to create a substantially homogenous solution, quenching the homogenous solution to obtain a homogeneous solid, reheating the solid to a temperature of 1150° C. for 20 hours, quenching the reheated solid, crushing the quenched solid, milling the crushed solid for eight hours, and annealing the milled solid at a temperature of 400° C. for 10 minutes.

### BRIEF DESCRIPTION OF THE DRAWINGS

FIG. 1 is a flowchart illustrating a method of producing magnetic alloys according to one embodiment.

FIG. 2 shows an X-ray diffraction pattern of Mn₅₄Al₄₆ prior to annealing.

FIG. 3 shows an X-ray diffraction pattern of Mn₅₄Al₄₆ annealed at 400° C. for thirty minutes.

FIG. 4 shows an X-ray diffraction pattern of Mn₅₄Al₄₆ annealed at 500° C. for thirty minutes.

FIG. 5 shows an X-ray diffraction pattern of Mn₅₄Al₄₆ annealed at 600° C. for thirty minutes.

FIG. 6 shows room temperature dependence of saturation magnetization and coercive field on annealing temperatures for bulk un-milled samples.

FIG. 7 shows room temperature dependence of saturation magnetization and coercive field on annealing temperatures for mechanically milled samples.

FIG. 8 shows room temperature hysteresis loops in a 15 kOe field for mechanically milled (MM) and bulk Mn₅₄Al₄₆ powders annealed at 400° C. for ten minutes.

FIG. 9 shows room temperature hysteresis loops in a 50 kOe field for mechanically milled (MM) and bulk Mn₅₄Al₄₆ powders annealed at 400° C. for ten minutes.

FIG. 10 shows room temperature isothermal remanence magnetization (IRM) and dc demagnetization (DCD) curves for mechanically milled Mn₅₄Al₄₆ annealed at 400° C. for ten minutes.

FIG. 11 shows room temperature isothermal remanence magnetization (IRM) difference curves for bulk and mechanically milled Mn₅₄Al₄₆ annealed at 400° C. for ten minutes.

FIG. 12 shows the room temperature dependence of the coercive field on the magnetic field strength for mechanically milled and bulk Mn₅₄Al₄₆ powders annealed at 400° C. for ten minutes.

FIG. 13 shows dependence of saturation magnetization on annealing temperatures for mechanically milled and bulk samples of various composition.

FIG. 14 shows dependence of coercivity on annealing temperatures for mechanically milled and bulk samples of various composition.

### DETAILED DESCRIPTION

Methods for producing mechanically milled, nanostructured Mn—Al and Mn—Al—C alloys will now be shown and described. High room temperature coercivities and saturation magnetization values have been achieved for Mn—Al alloys that are produced by the presently described methods, and it has been shown that the addition of small amounts of carbon (e.g., about 3 atomic % or less) to Mn—Al alloys stabilizes the metastable τ phase and improves magnetic properties.

Mechanically milled Mn—Al alloys possessing a L1₀-structured magnetic τ phase, with H_{C}=4.8 kOe and M_{S}=87 emu/g at room temperature, were obtained by annealing Mn₅₄Al₄₆ powders at 400° C. for 10 minutes. The coercivity value of this alloy is the highest ever reported for Mn—Al materials. The amount of magnetic τ phase present in the annealed product is estimated from the saturation magnetization (M_{S} of pure τ phase is ˜110 emu/g) to be about 80%. In another embodiment, a Mn—Al—C alloy, Mn₅₁Al₄₆C₃, prepared by the same method displayed a coercivity that is the highest ever reported for Mn—Al—C materials, H_{C}=5.2 kOe.

The macroscopic formulas presented herein, e.g., Mn₅₄Al₄₆, pertain to the overall composition, but the materials have nanostructure or microstructure of localized phase variation (e.g., γ, β, and/or τ phases). As used herein, a “nanostructured” material is a bulk solid characterized by localized variation in composition and/or structure such that the localized variation contributes to the overall properties of the bulk material.

The large coercive forces observed are believed to result from small grains of the magnetic τ phase (˜30 nm) being magnetically isolated from one another. This lack of magnetic exchange coupling may result from non-magnetic phases (e.g., β, γ) inhibiting changes in the alloy's internal magnetization when an external magnetic field is applied (i.e., the non-magnetic phase(s) act as magnetic domain wall pinning sites).

The alloys disclosed herein are resistant to corrosion and may, for example, be used in applications currently utilizing known permanent magnets. In one embodiment, small particles or powders of the alloys may be produced in a resin or plastic bonded form according to known methods. The small grain size of the alloys may provide improved ductility relative to materials with larger grains.

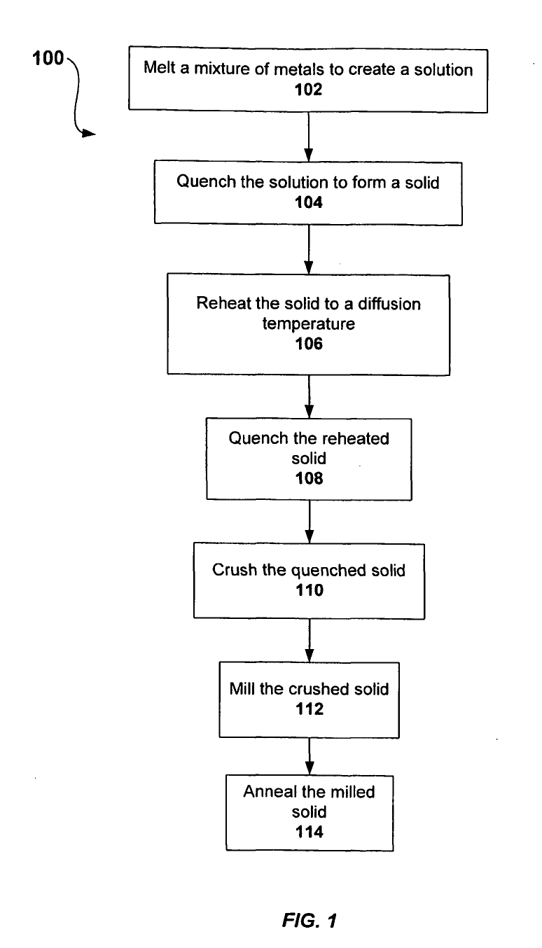

FIG. 1 is a flowchart illustrating a method 100 of producing magnetic alloys according to one embodiment. In a first step 102, a mixture of metals, which may be in the form of ingots, powders, ribbons, pellets or the like, is melted to provide a liquid solution. In a second step 104, the liquid solution is quenched to form a solid solution. Steps 102 and 104 may be repeated to ensure that adequate mixing results in the formation of a substantially homogeneous solid solution. A “substantially homogenous” solution has a uniform structure or composition throughout, such that in a randomized sampling of the solution at least 95% of the samples would have consistent compositions. In step 106, the substantially homogenous solid solution is reheated to a diffusion temperature that is just below the melting temperature of the solid. The solid is held at the diffusion temperature for a period of time that is sufficient for the solid diffusion process to reach completion. For example, the solid may be held at the diffusion temperature for twenty hours. In step 108, the solid is quenched, e.g., with water, to halt the diffusion process, and isolate the solid without structural rearrangement that would otherwise occur in a slow cooling process. In steps 110 and 112, the quenched solid is crushed and milled to repeatedly fracture and cold weld the particles in order to form a nanostructured material. The milling is sufficient to cause a rupture of the crystals of the alloy as well as to allow sufficient interdiffusion between the elementary components. In step 114, the milled solid is annealed to ensure complete formation of the nanostructured magnetic alloy.

### Example 1

### Production of Mn₅₄Al₄₆

Mn₅₄Al₄₆ alloy ingots were prepared by arc-melting stoichiometrically balanced quantities of Mn and Al in a water-cooled copper mold (Tₘ≈1250-1350° C.). The melted metallic solution was then heated until molten. Quenching was performed by allowing the alloy to rapidly cool in the copper mold to a temperature of ˜30° C. in approximately 10 minutes. Ingots were flipped and melted a minimum of three times under argon to ensure mixing. Ingots were subsequently heated to and held at 1150° C. for 20 h followed by water quenching to retain the ε phase. The ingots were then crushed and milled for eight hours in a hardened steel vial using a SPEX 8000 mill containing hardened steels balls with a ball-to-charge weight ratio of 10:1. The vials were sealed under argon to limit oxidation. Both the as-milled powders and the quenched bulk samples were annealed at temperatures from 350-600° C. for 10-30 minutes to produce the ferromagnetic L1₀ τ phase.

The magnetic properties were measured at a room temperature of about 20° C. using a LakeShore 7300 vibrating sample magnetometer (VSM) under an external magnetic induction field of 15 kOe. Some samples were also measured with an Oxford superconducting quantum interference device (SQUID) magnetometer under a field of 50 kOe. Accuracy of the magnetic measurements is within ±2%. Therefore, magnetic data may be reported as “about” a particular value to account for ubiquitous sources of error (e.g., magnetic fields within or near the magnetometer and errors associated with weighing samples). Microstructural characterization was performed using a Siemens D5000 diffractometer with a Cu X-ray tube and a KeVex solid state detector set to record only Cu Kα X-rays.

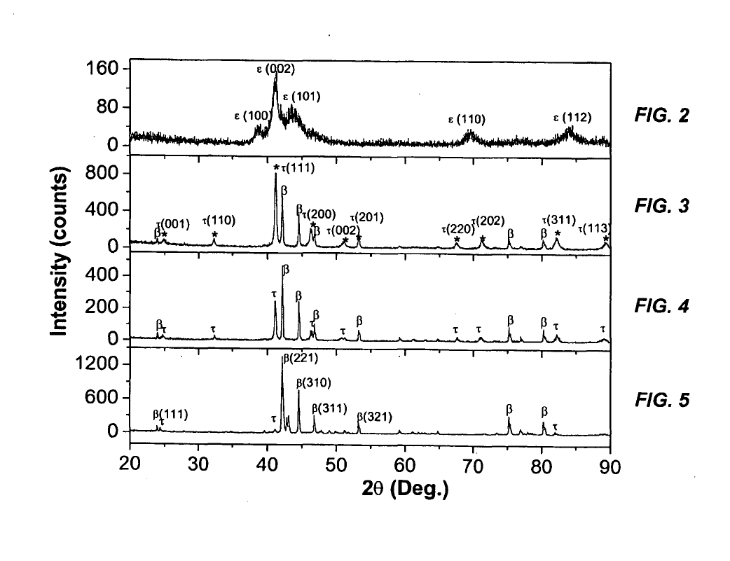

FIGS. 2-5 show X-ray diffraction patterns of Mn₅₄Al₄₆ annealed at various temperatures. X-ray diffraction patterns for as-milled alloys showed peaks corresponding to the h.c.p. ε phase of the MnAl alloy. As shown in FIG. 2 the diffraction peaks were broad and of low intensity, indicative of a nanocrystalline grain structure. The grain size of the ε phase calculated from the (111) X-ray peak using the Schemer formula was 8 nm. Annealing the as-milled sample of Mn₅₄Al₄₆ at 400° C. for 30 minutes caused the c phase to transform to the f.c.t. τ phase. FIG. 3 shows peaks indicative of the τ phase marked by asterisks. The calculated τ phase grain size was ˜27 nm, which is much smaller than that produced by conventional casting, grinding or extruding. Without being bound by theory, the smaller grain size appears to result from the τ phase forming from the nanocrystalline c phase. Increasing the annealing temperature to 500° C. for 30 minutes caused decomposition of the τ phase, as shown in FIG. 4 by a decrease in intensity of the τ phase peaks. Annealing at 600° C. for 30 minutes resulted in a minimal presence of the τ phase in the final product, as shown in FIG. 5.

These results show that the improved magnetic performance may be related to small grain sizes, where the nanostructured ε phase material is transformed to the ferromagnetic τ phase at anneal conditions characterized by the 400° C. anneal which produced the results of FIG. 3. The effective temperature range for this anneal is between 300° C. and 600° C., and more preferably from 350° C. to 500° C., and most preferably from 350° C. to 450° C. The smaller grain sizes are facilitated by the milling that occurs just prior to the anneal.

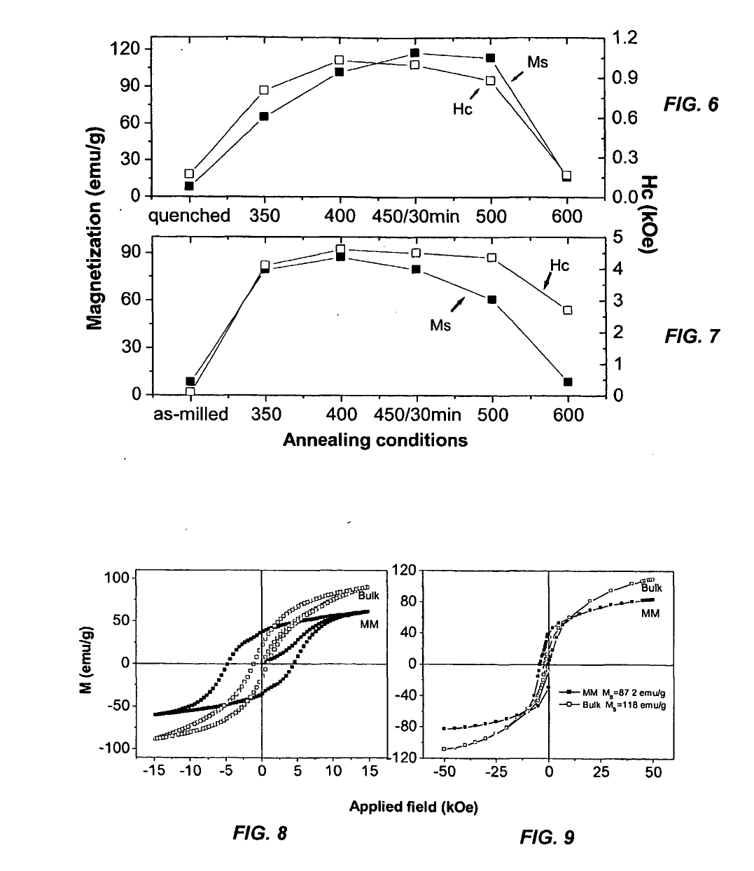

FIGS. 6 and 7 show the sensitivity or dependence of saturation magnetization, M_{S}, and coercivity, H_{C}, upon annealing temperatures for both bulk (FIG. 6) and mechanically milled (FIG. 7) Mn₅₄Al₄₆. For bulk samples, the M_{S} tends to increase with increasing annealing temperature from 300° C. to 500° C. The M_{S} for mechanically milled Mn₅₄Al₄₆ increases from 350° C. to 400° C., then decreases with increasing annealing temperature from 400° C. to 600° C. This is consistent with the X-ray diffraction data (FIGS. 3-5) that showed the volume fraction of the magnetic τ phase decreasing with annealing temperatures above 400° C. The H_{C} changes relatively little from 350° C. to 500° C. for mechanically milled samples. The optimal magnetic properties for mechanically milled samples, H_{C}=4.8 kOe, and M_{S}=87 emu/g, were obtained for Mn₅₄Al₄₆ powders annealed at 400° C. for 10 minutes. The coercivity value of the mechanically milled alloy is the highest reported to date for Mn—Al magnetically isotropic powders. In general, the M_{S} obtained for annealed, mechanically milled samples was lower than that obtained in bulk samples, while the H_{C} was higher, due to the small τ phase grain size.

FIGS. 8 and 9 show room temperature magnetic hysteresis loops for mechanically milled (solid squares) and bulk (open squares) Mn₅₄Al₄₆ powders annealed at 400° C. for 10 minutes. FIG. 8 shows hysteresis loops in a 15 kOe field. Coercivity is measured as the distance along the x-axis from the origin to the intersection of the curve with the x-axis. It can be seen that the mechanically milled sample has a much larger coercivity (˜5 kOe) than the bulk sample (˜1 kOe). Remanent magnetization, Mᵣ, is the intrinsic field of the sample when the applied field is zero. Mᵣ of the mechanically milled sample is approximately 35 emu/g, while that of the bulk sample is approximately 25 emu/g. FIG. 9 shows hysteresis loops in a 50 kOe applied field. Magnetic saturization, M_{S}, has not been reached, as evident from the increasing magnetization at high fields. For the mechanically milled sample, the remanence ratio, Mᵣ/M_{S}, is about 0.5 when the applied field is 50 kOe, which is characteristic of materials that are not exchange-coupled.

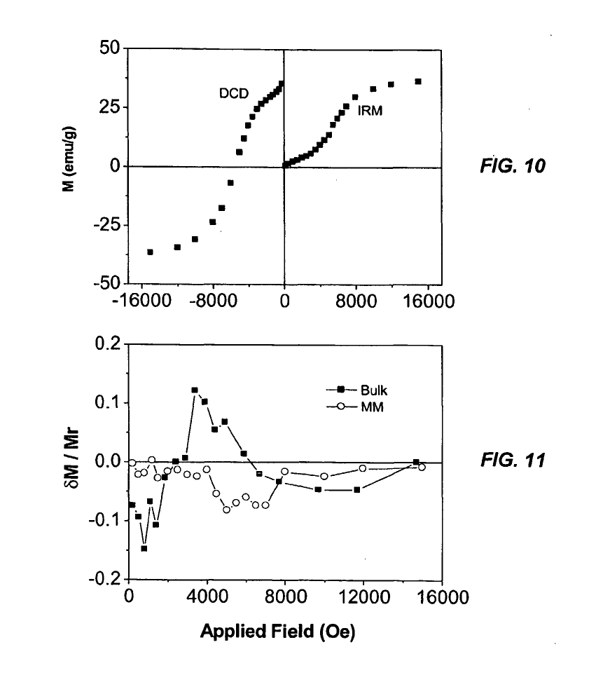

FIGS. 10 and 11 show isothermal remanence magnetization (IRM), dc demagnetization (DCD) and difference curves for mechanically milled Mn₅₄Al₄₆ annealed at 400° C. for 10 minutes. FIG. 10 shows the IRM and DCD curve for the mechanically milled sample, and FIG. 11 shows the δM curves for both mechanically milled and bulk samples annealed at 400° C. for 10 minutes. Remanence curves and δM plots were used to determine the interaction between the τ-phase grains. The dc demagnetization (DCD) curve shows the progress of the irreversible changes in magnetization. The isothermal remanence (IRM) curve contains contributions from both reversible and irreversible magnetization processes. δM is defined as M_{d} (H)−[Mᵣ(Hₛₐₜ)−2Mᵣ(H)]. A plot of δM versus H therefore gives a curve characteristic of the interactions present. The overall negative and small δM for the mechanically milled sample indicates that most of the τ phase nanograins are isolated with only small dipolar interactions between them. No exchange coupling exists in this nanostructured material, which explains why the remanence ratio is close to 0.5.

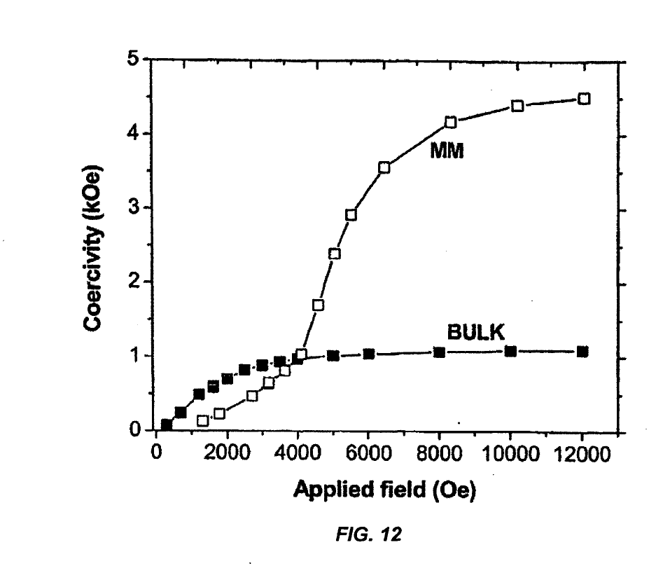

FIG. 12 shows the dependence of the coercive field on the magnetic field strength for mechanically milled and bulk Mn₅₄Al₄₆ powders annealed at 400° C. for 10 minutes. The bulk sample curve rises steadily to near saturation. In contrast, the mechanically milled sample curve rises gradually at low fields until the field strength approaches H_{C} (5 kOe), then it rises quickly to near saturation. This behavior indicates that the mechanism for the magnetization process of the mechanically milled material is controlled by domain wall pinning, and that the applied field gradually removes the domain walls from their pinning sites. The non-magnetic phase(s) that are present could act as the pinning sites.

### Example 2

### Alloy Content Sensitivity

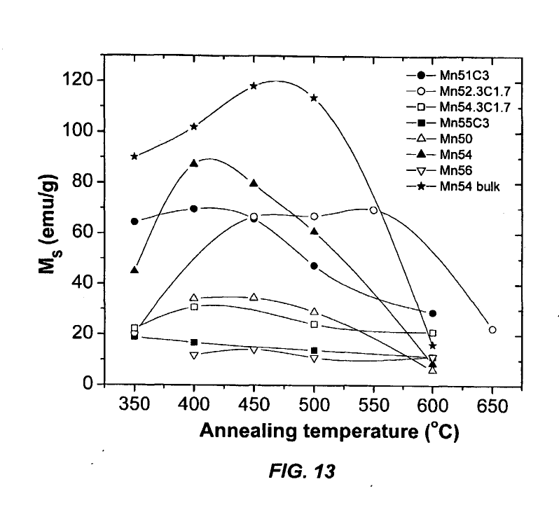

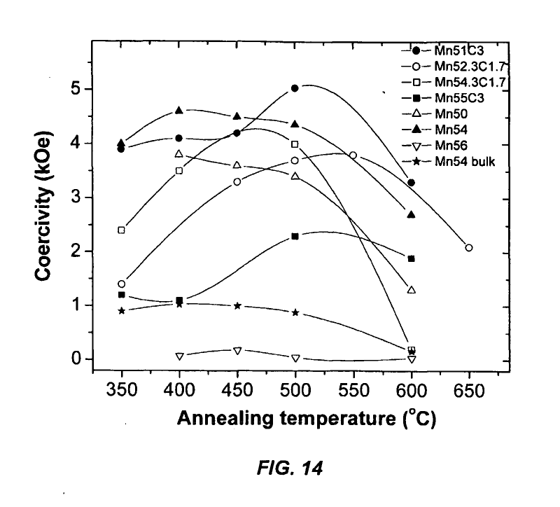

The manufacturing process of Example 1 was repeated by varying the content of the Mn and Al metals, and doping with carbon. FIGS. 13 and 14 show the dependence of saturation magnetization and coercivity on annealing temperatures for mechanically milled and bulk samples of various composition after the samples had been annealed for thirty minutes. The legends of FIGS. 13 and 14 show Mn content, and optionally C content, where the remainder of the sample is Al. All samples are mechanically milled, except for those labeled “bulk”. It can be seen that 1-3 atomic % carbon decreased M_{S} but increased H_{C} in some cases. In particular, Mn₅₁Al₄₆C₃ had the highest H_{C} observed to date for a Mn—Al—C alloy, 5.2 kOe. Dopants other than carbon may include boron and the rare earth metals. Generally, it can be noted that because the t phase is the only ferromagnetic phase in the Mn—Al or Mn—Al—C systems, the saturation magnetization is proportional to the percentage of the τ phase in the alloys. When the Mn content is 50 atomic percent or less, little ε phase can be developed, and therefore only a small amount of τ phase can be produced. Also, when the Mn content is high, excess Mn is used to stabilize the metastable τ phase. In this case, some Mn atoms occupy lattice sites where they are coupled antiferromagnetically to other nearby Mn atoms, thereby reducing the magnetization. Thus, the Mn content is preferably between 52 and 58 atomic percent and the alloys may be described according to Formula (I);

Mn_{X}Al_{Y}Do_{Z}, (1)

wherein

Do is a dopant,

X ranges from 52-58 atomic %,

Y ranges from 42-48 atomic %, and

Z ranges from 0 to 3 atomic %.

In a more preferred sense:

Do is carbon,

X ranges from 53-56 atomic %,

Y ranges from 44-47 atomic %, and

Z ranges up to 3 atomic %.

In a most preferred sense, X is 54, Y is 46, and Do is not necessarily present.

The above description of the specific embodiments may be modified and/or adapted for various applications or uses that do not depart from the general scope hereof. Therefore, such adaptations and modifications should and are intended to be comprehended within the meaning and range of equivalents of the disclosed embodiments. It is to be understood that the phraseology or terminology employed herein is for the purpose of description and not limitation.

This specification contains numerous citations to references such as patents, patent applications, and publications. Each is hereby incorporated by reference.

What is claimed is:

1. An intermetallic composition comprising a nanostructured manganese aluminum alloy comprising at least about 80% of a magnetic τ phase and having permanent magnetic properties.

2. The intermetallic composition of claim 1, wherein the manganese aluminum alloy has a macroscopic composition of Mn_{X}Al_{Y}Do_{Z}, wherein
Do is a dopant,
X ranges from 52-58 atomic %,
Y ranges from 42-48 atomic %, and
Z ranges from 0 to 3 atomic %.

3. The intermetallic composition of claim 2 produced by a process comprising the steps of:
heating a mixture of metals comprising manganese and aluminum to create a substantially homogenous solution;
quenching the homogenous solution to obtain a homogeneous solid;
reheating the solid to a temperature of 1150° C. for 20 h;
quenching the reheated solid;
crushing the quenched solid;
milling the crushed solid for 8 h; and
annealing the milled solid at a temperature of 400° C. for 10 minutes.

4. The intermetallic composition of claim 1, wherein the manganese aluminum alloy has a macroscopic composition of Mn_{X}Al_{Y}Do_{Z}, wherein
Do is carbon,
X ranges from 53-56 atomic %,
Y ranges from 44-47 atomic %, and
Z ranges from 0 to 3 atomic %.

5. The intermetallic composition of claim 1, wherein the manganese aluminum alloy has a macroscopic composition of Mn₅₄Al₄₆.

6. The intermetallic composition of claim 1, wherein the permanent magnetic properties comprise coercive forces of about 4.8 kOe.

7. The intermetallic composition of claim 1, wherein the permanent magnetic properties comprise a saturation magnetization value of at least about 87 emu/g.

8. The intermetallic composition of claim 1, wherein the manganese aluminum alloy further comprises carbon.

9. The intermetallic composition of claim 8, wherein the manganese aluminum alloy further comprising carbon has a macroscopic composition of Mn₅₁Al₄₆C₃.

10. The intermetallic composition of claim 9, wherein the permanent magnetic properties comprise coercive forces of about 5.2 kOe.

11. A nanostructured manganese aluminum alloy comprising at least about 80% of a magnetic τ phase and having a macroscopic composition of Mn_{X}Al_{Y}Do_{Z}, wherein
Do is a dopant,
X ranges from 52-58 atomic %,
Y ranges from 42-48 atomic %, and
Z ranges from 0 to 3 atomic %.

12. The nanostructured manganese aluminum alloy of claim 11, wherein the dopant is carbon.

13. The nanostructured manganese aluminum alloy of claim 11, wherein the manganese aluminum alloy has a macroscopic composition of Mn₅₄Al₄₆.

14. The nanostructured manganese aluminum alloy of claim 11, wherein the manganese aluminum alloy has a macroscopic composition of Mn₅₁Al₄₆C₃.

15. A method of producing an intermetallic composition comprising:
heating a mixture of metals comprising between 52-58 atomic % manganese and between 42-48 atomic % aluminum to create a substantially homogenous solution;
quenching the homogenous solution to obtain a homogeneous solid;
reheating the solid to a temperature of 1150° C. for 20 h;
quenching the reheated solid;
crushing the quenched solid;
milling the crushed solid for 8 h; and
annealing the milled solid at a temperature of 400° C. for 10 minutes.

16. The method of claim 15, wherein the mixture of metals comprises 54 atomic % manganese and 46 atomic % aluminum.

17. The method of claim 15, wherein the mixture of metals further comprises a dopant, the dopant selected from the group consisting of carbon, boron and rare earth metals.

18. The method of claim 17, wherein the mixture of metals comprises 51 atomic % manganese, 46 atomic % aluminum and 3 atomic % carbon.

19. The method of claim 15, further comprising the step of forming the annealed solid into a monolithic mass.

20. The method of claim 19, further comprising mixing the annealed solid with a bonding agent.
